(19) United States
(12) Patent Application Publication
(10) Pub. No.: US 2016/0282051 A1
(43) Pub. Date: Sep. 29, 2016

(54) APPARATUS AND PROCESS FOR QUICK COOLING HEAT EXCHANGER IN CARBON BLACK PRODUCTION

(71) Applicant: CONTINENTAL CARBON COMAPNY, Houston, TX (US)

(72) Inventors: Cuddalore P. Natarajan, Wexford, PA (US); Vimal K. Dubey, Ghaziabad (IN)

(21) Appl. No.: 15/036,332

(22) PCT Filed: Nov. 13, 2014
(86) PCT No.: PCT/US2014/065358

§ 371 Date: May 12, 2016

Related U.S. Application Data
(60) Provisional application No. 61/903,767, filed on Nov. 13, 2013.

(51) Int. Cl. F28D 7/00; C09C 1/50; B01J 12/02; F28D 7/16; B01J 12/00

(52) U.S. Cl. CPC F28D 7/0041; F28D 7/1653; B01J 12/005; B01J 12/02; C09C 1/50; F28D 2021/0075

(57) ABSTRACT

Effluent from a carbon black reactor is directly discharged FIG. 2 from the reactor to a quick cooling radiant heat exchanger before, or in some instances after, a reaction-stopping water quench. The cooled reaction quench is then supplied to an air preheater to preheat the carbonaceous feed stock that is supplied to the reactor. The heat exchanger includes a chamber having outside walls formed by heat exchanger tubes which are welded together. If desired, additional cooling capacity is provided by platens formed of heat exchanger tubes which are contained in the chamber to which the reactor effluent is supplied.

### CROSS-REFERENCE TO RELATED APPLICATION

This application claims the benefit of U.S. Provisional Patent Application Ser. No. 61/903,767, filed Nov. 13, 2013, the disclosure of which is hereby incorporated by reference in its entirety.

### FIELD OF THE INVENTION

The present disclosure is generally directed to the production of carbon black by furnace processes and, in particular, to efficiencies in the quench cooling of reactions in such processes. In this regard, an important aspect of this disclosure concerns minimizing and/or eliminating quenching with a water spray in a carbon black reactor to achieve the desired temperature reduction in the reaction effluent and minimizing or eliminating loss of quench water to the atmosphere as well as increasing the recovery of heat generated in the reaction process.

### BACKGROUND OF THE INVENTION

In the production of carbon black by the furnace process, the carbonaceous feed stock is injected into a high-temperature flame (about 1925° C.) containing excess oxygen. The cracking reaction should be stopped quickly (around 1300° C.) to arrest the reaction and increase the yield of carbon black. Without such quick cooling, secondary reactions will continue and the yield of carbon black will be reduced. This quick cooling is conventionally achieved by quenching with a water spray. Further cooling of the effluent to a carbon black collector, typically a bag filter, is achieved by a combination of water spray and heat exchangers.

### DESCRIPTION OF THE PRIOR ART

Water sprays have been traditionally used to quench the effluent and arrest the cracking reaction. Water sprays have also been used to control the performance of downstream heat exchangers for useful energy recovery and for useful carbon black collector entry temperature. Such water must be treated to reduce the impurities content for product quality as well as for trouble-free operation of the downstream equipment due to the deposition of such impurities on the surfaces of the equipment. Furthermore, water, being an increasingly important commodity, is lost to the atmosphere and not recovered.

In some instances, quench cooler-type heat exchangers have been used. These are essentially a tube-inside-tube type heat exchanger with multiple tubes. The furnace effluent flows through the inner tube and a cooling medium, typically boiler water, flows in the annulus between the inner and outer tubes. The heat from the effluent is transferred to the boiling water through the walls of the inner tubes. The boiling water is converted to steam and separated in an external steam drum and put to use in the process or sold to other users.

In this type of heat exchanger, the effluent flows through the inner tubes at high velocity and the primary mode of heat transfer is by convection; the higher the velocity, the higher the convective heat transfer. The velocity of the effluent solid particles in suspension reduces fouling of the tubes. The high velocity also helps scrub the tube walls of any fouling. However, as the tubes have a low curvature, some grades of carbon black like carcass or soft carbon blacks tend to stick to the tube walls and increase fouling and eventually fully block the tubes.

The apparatus and process of this disclosure provide increased heat transfer rates to the heating surfaces by achieving a high heat flux per unit volume of the apparatus and by utilizing process parameters and mechanical means to minimize the fouling on the heating surfaces by the carbon black.

### SUMMARY OF THE PRESENT DISCLOSURE

In accordance with the present disclosure, effluent from a carbon black reactor can be directly discharged without any prior water spray quenching into a quench boiler (also referred to herein as a “radiant heat exchanger”) or, in some instances, after a reaction-stopping quench which may be desired for production reasons.

This effluent, after the reaction-stopping quench, has considerable amounts of CO, CO₂ and H₂O which are capable of emitting and absorbing heat radiation at high temperatures. The radiactive flux is a function of their partial pressure in the effluent and the radiating beam length, as well as the temperature of the effluent. Also, the radiactive flux is proportional to the fourth power of the absolute temperature of the radiating medium and the absorbing medium.

The effluent from the reactor is at high temperature (typically around 1300° C.) and at high velocity (typically around 60 to 75 meters per second) enters a chamber which can be bounded by tubes, welded together to form the walls of a chamber. Cooling medium, typically boiling water at high pressure (for example, about 600 psig to 1500 psig), flows inside the tubes. Heat given up by the effluent is transferred to the boiling water primarily by radiation. The radiant beam length, being a function of the chamber dimensions, is larger than that of a smaller diameter tube and results in higher radioactive flux. The dimensions of this larger chamber result in a lower curvature than those associated with the previously described prior art tube-inside-tube heat exchangers, thereby reducing the fouling tendency. For example, radiant heat exchangers used in quench cooling of effluent from a carbon black reactor as described in this disclosure will produce radiant beams having a length of up to 10 or more times the radiant beam length of prior art tube-inside-tube heat exchangers used similar carbon black production environments.

In one configuration, the chamber is bounded by four flat walls. The chamber itself is made of two sections, arranged side by side, with the effluent flowing vertically upwardly through the first section and vertically downwards in the second section. In this configuration, hammers can be provided on the outside walls to periodically rap the walls to clear any deposits on the walls.

In another configuration, the chamber is fitted with multiple hanging platens, made up of tubes through which the same cooling medium flows. This effluent from the furnace flows into this chamber and the reaction is arrested inside the chamber by heat transfer. No water spray to stop the reaction is required. These platens have both sides of the tubes taking part in the heat transfer. Provision can be made to externally rap these platens by suitable periodic hammering which can be either manual or automated. This configuration can also be used after an upstream reaction stopping quench.

If desired, high-pressure, high-saturation temperature boiling water may be used as a cooling medium to keep the tubes of the heating surface warmer to minimize fouling of the tubes by carbon black.

Alternatively, other cooling mediums such as, for example, dewatered tail gas from downstream in the carbon black production may be used as a cooling medium.

As desired, other means for cleaning the tubes such as, for example, sonic horns may be used. The medium for such sonic horn should be compatible with the properties of the effluent to avoid the risk of damage to the apparatus.

It is to be understood that both the foregoing general description and the following detailed description are exemplary and provided for purposes of explanation only and are not restrictive to the subject matter claimed. Further features and objects of the disclosure will become more apparent from the following description of the example embodiments.

### DESCRIPTION OF THE DRAWINGS

In describing the illustrative examples, reference is made to the accompanying drawing figures wherein like parts have like reference numerals and wherein:

FIG. 1 is a flow sheet of a carbon black production plant in which a quench boiler of the present disclosure is utilized;

FIG. 2 is a schematic of an illustrative two-pass quench boiler of the present disclosure;

FIG. 3 is a fragmentary schematic of the walls of the quench boiler shown in FIG. 2 showing the tubes in the outside walls which are attached by welded membranes;

FIG. 4 is a schematic cross-sectional view of the quench boiler shown in FIG. 2 taken along the lines 4-4;

FIG. 5 is a schematic view like FIG. 2 in which the cross-section of tubes making up the individual platens are shown;

FIG. 6 is an elevational view of the quench boiler of FIG. 2 showing the operative components of the quench boiler in greater detail;

FIG. 7 is a side elevational view of the first pass of the quench boiler of FIG. 6 as viewed from the 7-7 direction;

FIG. 8 is a view like FIG. 7 shown from the opposite side of the first pass shown in FIG. 8 as viewed from the 8-8 direction.

### DESCRIPTION OF THE ILLUSTRATED EMBODIMENTS

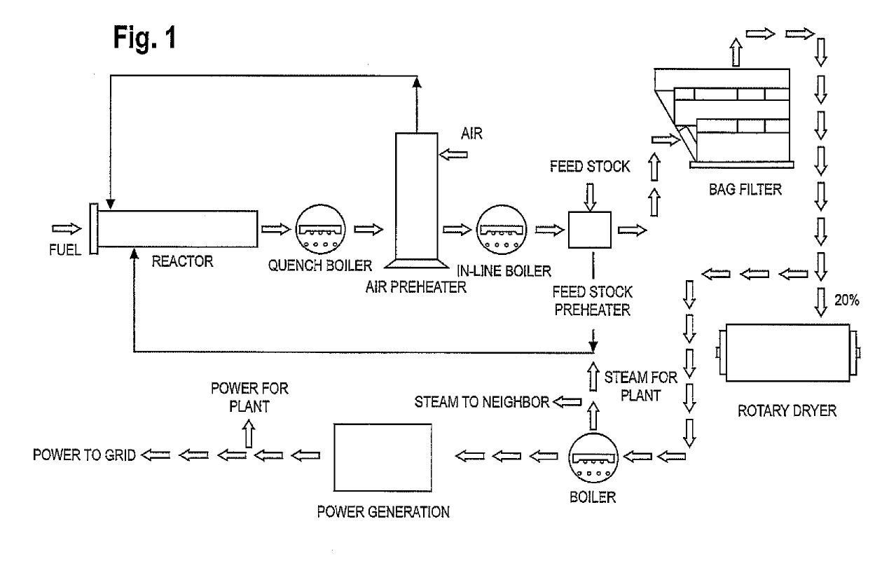

Referring to the drawings, and, in particular, to FIG. 1, a plant for production of carbon black by the furnace process is depicted. As shown, the carbon black reactor is supplied with fuel and air from an air preheater which produces a high-temperature flame, e.g., around 1925° C., containing excess oxygen. Carbonaceous feed stock is injected into the high-temperature flame that results in a cracking reaction that is stopped by quick cooling. Injection of the feed stock brings the temperature down to approximately 1500 to 1550° C. without a water spray quench and approximately 1300° C. if a reaction stopping spray quench is employed.

In the illustrated embodiment, heat recovered from cooling the effluent to 1000° C. is used to generate steam. The 1000° C. effluent then enters the air heater where the process air is preheated to around 850° C., cooling the effluent to around 650° C. This effluent is then transferred to an inline boiler and a feed stock preheater, wherein the effluent heat is used to generate steam and to preheat the feed stock respectively, resulting in further temperature reduction of the effluent so that it can be supplied to a carbon black collector, typically a bag filter.

The effluent from the quench boiler will typically be approximately 1000° C. and the effluent to the bag filter will typically be approximately 250° C. to 260° C.

Further processing of the effluent from the bag filter can be done in a conventional manner.

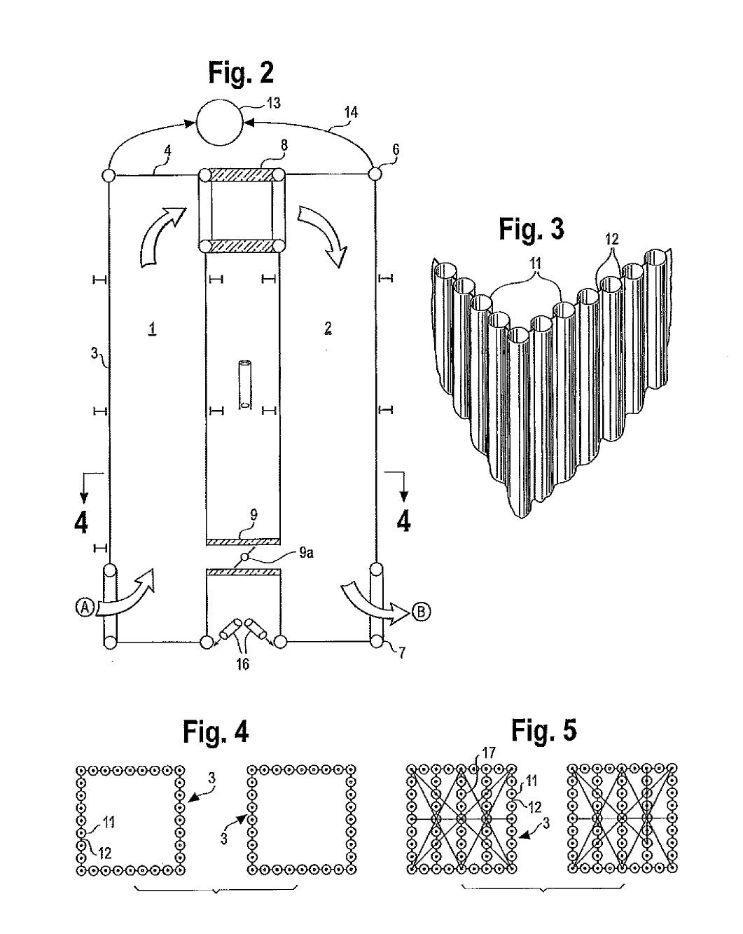

FIG. 2 depicts a quench boiler designated by the reference numeral 10 which embodies features of the present invention. In this illustrative embodiment, the quench boiler 10 is made of two sections generally designated by reference numerals 1 and 2 which are arranged side by side with the effluent flowing vertically upwardly in radiant section 1 and downwardly in radiant section 2. The bounding wall as shown in FIG. 3 is made up of tubes 11 which are welded with membranes 12 around the outside perimeters of the quench boiler 10. It will be appreciated that the vertical configuration of the chambers in this illustrated embodiment is utilized in order to fit existing space and to economize on the amount of ground space needed.

The space between the walls 3 in each of the radiant sections 1 and 2 is open so that the tube wall facing the smoke is the effective area for heat transfer. The outside of these walls is preferably insulated to prevent heat loss to the surrounding atmosphere. In this embodiment, the individual tubes typically have an outer diameter of about 2 to 2½ inches and spacing between individual tubes will be from about ½ inch to 1 inch.

As schematically shown, reference numeral 4 designates the roof of the radiant sections 1 and 2 and reference numeral 5 designates the floor of those radiant sections. Headers 6 are provided to collect the cooling medium (steam-water mixture) after absorbing the heat from the effluent and headers 7 distribute the cooling medium prior to absorbing the heat from the effluent. The tubes 11 are connected by welding to the headers 6 and 7.

A short refractory-lined connector 8 is provided between radiant sections 1 and 2 and a refractory-lined bypass duct 9 with a water-cooled damper 9a can be provided to control bypass flow.

As shown, heated cooling medium (steam-water mixture) flows from headers 6 through riser pipes 14 and is collected into an external steam drum 13. The steam drum can be provided with traditional means for separation of the steam from the water such as, for example, turbo separators and mesh pad-type demisters (not shown) where the steam-water mixture is sent through a tortuous path made by corrugated closely spaced plates which separate the steam from the water. Flows from the steam drum can be used in the process itself or sold to users of steam. The separated water from the steam drum 13 flows out the downcomer 15 and headers 7 through feeder pipes 16.

In order to reduce the volume of the radiant sections and thereby reduce the residence time of the effluent within the apparatus, additional heating surfaces can be provided such as, for example, by platens 17 as is schematically depicted in FIG. 5. As shown, these platens 17 are made up of tubes 11 and are individually connected to the top and bottom headers by welding and suspended inside of the radiant section. Feeders connected to the header 7 bring the cooling medium to the platen tubes. The cooling medium (steam and water mixture) flows into the headers 6.

The radiant section water walls 3 (FIG. 5) can be provided with wall rappers (not shown) to periodically vibrate the tubes 11 to dislodge any deposits on the tubes. A rapper can consist of an armored plate welded to a tube with a swinging or pneumatic hammer hitting the armor plate to create the vibration of the tubes. Correspondingly, the suspended platens 17 can be provided with external rappers (not shown) to periodically vibrate the platen tubes to dislodge any deposits in the tubes. These rappers can typically consist of an extended bottom header of the platen, which is hit with a swinging pneumatic hammer to create vibration of the platen tubes.

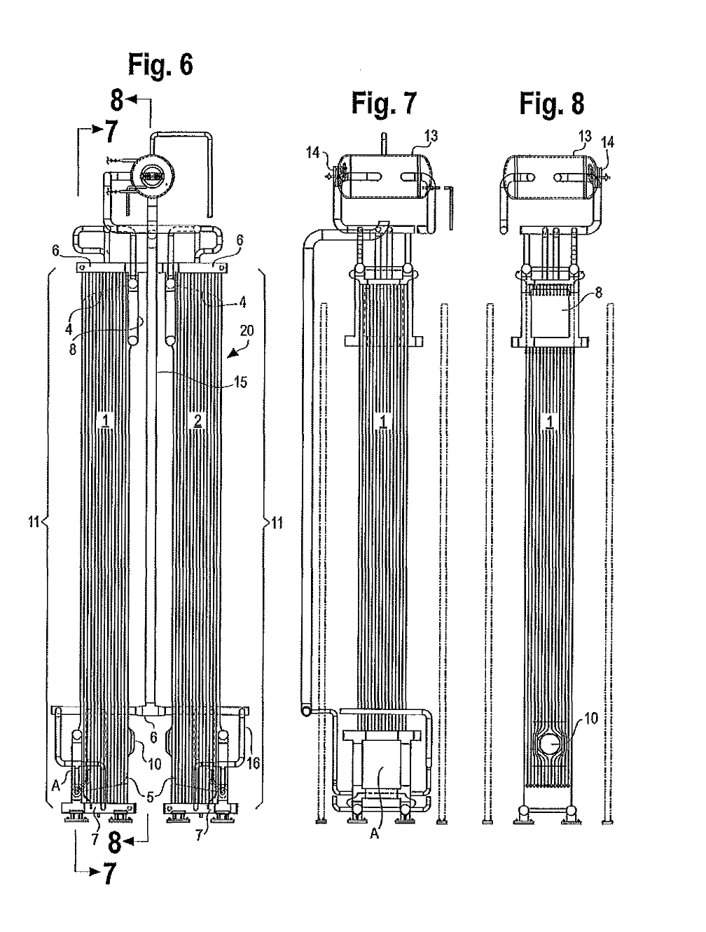

FIGS. 6-8 show the key operative components of a quench cooler 20 of the present invention in greater detail than is shown in FIG. 2-5. As previously noted, identical reference numbers are used for counterpart components. In particular, FIG. 6 shows the first and second passes, the first pass (upward flow) 1 and second pass downward flow 2. Descriptions of these components with respect to FIGS. 1-5 is incorporated herein by reference to FIGS. 6-8.

### EXAMPLE

The following example illustrates the performance of the radiant heat exchanger of the present invention in two situations. In Case 1 effluent is supplied to the radiant heat exchanger from the reactor without any prior process quench (i.e., water spray quench) and in Case 2 effluent is supplied to the radiant heat exchanger after the reactor effluent was subjected to a reaction stopping spray water quench prior to being supplied to the radiant heat exchanger.

In a carbon black furnace, 15,884 nm3/h of hot air at 780 C is admitted along with adequate fuel to raise the flame to a temperature around 1900 C. Hot carbonaceous feed stock is sprayed in to this excess oxygen-containing hot flame. After the formation of carbon black, the volume of the effluent is 25,990 m3. The reaction is stopped by a water spray at round 1300 C. The calculated water spray of 2,220 kg/h results in 28,750 nm3 of gases. As this temperature is still too high for existing downstream heat exchanger, namely the reactor air preheater (APH), the gases are further cooled down by additional water spray of 3,350 kg/h to cool the gases to 1,000 C before entering this APH. The volume of gases entering the APH is 32,915 nm3/h. This amount of water (5,570 kg/h) is not recovered and will be lost into the atmosphere. This additional water also causes problems in the downstream equipment like the bag filter with wetness.

With the radiant heat exchanger, all or part of the water can be saved. A single radiant heat exchanger will cool the gases from 1550 C to 1000 C (case 1). In those cases, where, for carbon black quality influence, arresting of the reaction is carried out by water spray; the radiant heat exchanger is sized to cool the gases from 1,300 c to 1,000C. (case 2). The details of these two radiant heat exchangers are shown in Table 1. The cooling medium was boiling water at 98.5 kg/cm2 g (1,400 psig) corresponding to a saturation temperature of 309 C. High saturation temperature cooling medium is chosen to have warmer tube wall temperatures to reduce fouling by the carbon black.

The radiant heat exchanger is rectangular in cross section and is made up of two sections with 2 passes for the gases, up and down. The two sections are located as close to each other as practically feasible to provide access between the sections for maintenance. A refractory lined transfer duct connects the two sections. A bypass duct is provided with a suitable means to control the bypass flow, if required. Both the sections are provided with three platens, hung from the top to provide additional heating surfaces to maximize the surface area per unit volume of the heat exchanger.

Boiling water is fed from the external steam drum and heated water steam mixture from the radiant heat exchanger flows into this steam drum. Separated dry steam flows out of the steam drum for use. The heat exchanger is provided with on line cleaning mechanism of mechanical rappers or sonic horn to dislodge any fouling on the heating surfaces. A reasonable fouling resistance (0.008 m² h C/Kcal) has been incorporated to size the heat exchangers.

TABLE 1

| | | Case 1 | Case2 |
|---|---|---|---|
| Process Data: | | | |
| Heating side: | | | |
| Medium | | CB gases | CB gases |
| Volume of gases | nm³/h | 25,990 | 28,750 |
| Temperature of gases entering | C. | 1,550 | 1,300 |
| Temperature of gases leaving | C. | 1,000 | 1,000 |
| Heat Transferred | MM | 5.888 | 3.586 |
| | Kcal/h | | |
| Residence time to 1300 C. | S | 0.075 | — |
| Total residence time | S | 0.217 | 0.147 |
| Cooling side: | | | |
| Medium | | Boiling | Boiling |
| | | water | water |
| Saturation temperature | C. | 309 | 309 |
| Feedwater temperature | C. | 105 | 105 |
| Steam Pressure | kg/cm² g | 98.5 | 98.5 |
| Steam generation | kg/h | 10,788 | 6,570 |
| Heat Exchanger Data: | | | |
| Number of sections | | 2 | 2 |
| Cross section (width/breadth) | m/m | 0.762/ | 0.762/ |
| | | 0.762 | 0.762 |
| Height of each section | m | 7.93 | 5.26 |
| Number of platens | | 3 | 3 |
| Heating surface per section | m² | 60.39 | 40.06 |
| Total Heating surface | m² | 120.78 | 80.13 |
| Total Volume of Heat exchanger | m³ | 9.21 | 6.11 |
| Heating Surface to volume ratio | | 13.11 | 13.11 |

In summary, in the given example, the present invention will save 5,570 kg/h of quench water in case 1, but generate 10,788 kg/h of steam which can generate approximately 2.7 megawatts of electrical power. In case 2, quench water saved will be 3,350 kg/h, steam generation 6,570 kg/h, with electricity potential of 1.64 megawatt.

While the invention of this disclosure has been described with illustrative examples, it will be appreciated that modifications and/or variations may be made therefrom by those skilled in the art without departing from the spirit and scope of this invention as defined by the appended claims.

1. In a system for the production of carbon black by the furnace process which includes a reactor supplied with a fuel, preheated air and a carbonaceous feed stock, the improvement comprising:
a quick cooling radiant heat exchanger located between an effluent discharge outlet of the reactor and an air preheater,
said heat exchanger including a reactor effluent inlet in flow communication with the effluent discharge outlet of said reactor and an effluent outlet in flow communication with an effluent inlet of said air preheater,
a chamber in said heat exchanger, heat exchanger tubes in said chamber, said heat exchanger tubes being arranged to effect heat transfer primarily by radiation between reactor effluent flowing through said chamber and a cooling medium supplied to said heat exchanger tubes.

2. The improvement of claim 1 wherein said chamber is bounded by said heat exchanger tubes which are welded to each other to form the exterior walls of said chamber.

3. The improvement of claim 1 wherein said chamber is fitted with hanging platens made up of heat exchange tubes, said platens defining passages through which reactor effluent flows, whereby substantially the entire outer surface of said heat exchanger tubes in said platens is contacted by said reactor effluent.

4. The improvement of claim 1 wherein said chamber includes first and second chamber sections, each of which includes said heat exchanger tubes, whereby reactor effluent received in said heat exchanger inlet will flow from an outlet in said first chamber section to an inlet in said second chamber section and from the inlet of said second chamber section to an outlet in said second chamber section, said second outlet in said second chamber section being in flow communication with the effluent inlet to said air preheater.

5. The improvement of claim 4 wherein said first and second chamber sections are in generally side-by-side vertical orientation to each other.

6. The improvement of claim 5 wherein the reactor effluent flows upwardly in said first chamber section and downwardly in said second chamber section.

7. The improvement of claim 3 wherein a mechanical rapper or sonic horn may be provided to dislodge the buildup of carbon black on the surfaces of the heat exchanger tubes.

8. The improvement of claim 1 which includes a water spray reaction-stopping water quench station prior to said heat exchanger effluent inlet.

9. In the production of carbon black by a furnace process wherein a reactor is supplied with a fuel, preheated air and a carbonaceous feed to produce a reactor effluent, the improvement comprising:
supplying said reactor effluent to an inlet of a quick cooling radiant heat exchanger which includes a chamber and a plurality of heat exchanger tubes through which a cooling medium flows,
contacting said reactor effluent with the exterior surfaces of said heat exchanger tubes to effect heat transfer from said reaction effluent to said cooling medium primarily by radiation between the reactor effluent flowing through said chamber and the cooling medium supplied to said heat exchanger tubes,
discharging the cooled reaction effluent from said quick-cooling radiant heat exchanger through an outlet of said quick cooling radiation heat exchanger to an effluent inlet of an air preheater.

10. The improvement of claim 9 wherein said cooling medium is boiling water.

11. The improvement of claim 10 wherein said boiling water is at a pressure of from about 600 psig to about 1500 psig.

12. The improvement of claim 9 wherein said cooling medium is dewatered tail gas from downstream in the carbon black production.

13. The improvement of claim 9 wherein said reaction effluent is subjected to a reaction-stopping quench prior to being supplied to said inlet of said quick cooling radiation heat exchanger.

14. The improvement of claim 9 wherein the linear flow rate of said reactor effluent in said chamber of said heat exchanger is approximately 60 to 75 m/s
